(19) United States
(12) Patent Application Publication
(10) Pub. No.: US 2025/0347469 A1
(43) Pub. Date: Nov. 13, 2025

(54) HYDRAULIC OIL COOLING SYSTEM FOR VIBRATION TABLE

(71) Applicant: Tianjin University, Tianjin (CN)

(72) Inventors: Yan LU, Tianjin (CN); Qinghua HAN, Tianjin (CN); Jinyuan ZHANG, Tianjin (CN); Yuhao XU, Tianjin (CN); Zhipeng LI, Tianjin (CN)

(73) Assignee: Tianjin University, Tianjin (CN)

(21) Appl. No.: 19/023,501

(22) Filed: Jan. 16, 2025

(30) Foreign Application Priority Data
May 7, 2024 (CN) 202410553082.6

(51) Int. Cl. F28D 1/02; F28D 21/00; G01M 7/02

(52) U.S. Cl. CPC F28D 1/0206; G01M 7/02; F28D 2021/004

(57) ABSTRACT

A hydraulic oil cooling system includes an oil-water heat exchanger, a water-water heat exchanger, and a cooling pool; the cooling pool includes an internal reservoir, a corridor and an external reservoir arranged in turn from the inside out; the corridor is divided into a left flow-making corridor and a right flow-making corridor through two sets of partition walls, an internal and external reservoir channel for connecting the internal reservoir and the external reservoir is arranged under the partition wall; two sets of barrier walls separate the external reservoir into a left external reservoir and a right external reservoir, the left external reservoir and the right external reservoir are connected to the internal reservoir through one internal and external reservoir channel, respectively; and the corridor is connected to the external reservoir through a pumping pipe and a return pipe.

### CROSS REFERENCE TO THE RELATED APPLICATIONS

This application is based upon and claims priority to Chinese Patent Application No. 202410553082.6, filed on May 7, 2024, the entire contents of which are incorporated herein by reference.

### TECHNICAL FIELD

The present disclosure relates to the technical field of vibration tables and flow-making facilities, and in particular to a hydraulic oil cooling system for a vibration table.

### BACKGROUND

The large vibration table is a kind of equipment used to simulate earthquake, wind vibration and other vibration environment, and is widely used in engineering, construction, aerospace and earthquake research, comprising a platform with high rigidity and high stability and a vibration table slot. A structure or equipment to be tested is placed in the vibration table slot, the vibration at a specific frequency is produced through motor, hydraulic or electromagnetic drive systems, and the structure or equipment is subjected to mechanical vibration of different frequencies and amplitudes. Its advantages include simulating the real environment, high load capacity, wide frequency range, accuracy, repeatability and accelerated test cycle, and it is the most intuitive and effective large-scale equipment for studying seismic effects.

Usually, the working frequency of the vibration table is high, the working time is long, and the internal vibrator is easy to stop working due to the high temperature. In order to ensure that the vibration table is always in a working state, it is necessary to cool the vibrator. The large-scale vibration table has high rated power and large heat, so it is necessary to build a cooling pool to cool it. However, the existing cooling pool has a single function, great water consumption, low heat dissipation efficiency and large floor space, which is idle when the vibration table is not used.

### SUMMARY

An objective of the present disclosure is to provide a hydraulic oil cooling system for a vibration table, to address the above problems.

In order to achieve the above objective, the present disclosure provides a hydraulic oil cooling system for a vibration table, including:

an oil-water heat exchanger, which is configured to cool the hydraulic oil of the vibration table;

a water-water heat exchanger, which is configured to cool the oil-water heat exchange;

a cooling pool, which is configured to provide cooling water for the water-water heat exchanger; and

the cooling pool includes an internal reservoir, a corridor and an external reservoir arranged from the inside out; two sets of partition walls are arranged at an interior of the corridor, the two sets of partition walls divide the corridor into a left flow-making corridor and a right flow-making corridor, an internal and external reservoir channel for connecting the internal reservoir and the external reservoir is arranged under the partition wall; two sets of barrier walls are arranged at an interior of the external reservoir, the two sets of barrier walls separate the external reservoir into a left external reservoir and a right external reservoir, the left external reservoir and the right external reservoir are connected to the internal reservoir through one internal and external reservoir channel, respectively; and the left flow-making channel and the left external reservoir, as well as the right flow-making channel and the right external reservoir, are connected by a pumping pipe and a return pipe.

Further, both the oil-water heat exchanger and the water-water heat exchanger include a liquid tank and a radiating pipe located at an interior of the liquid tank, a liquid inlet and an outlet are arranged on both the liquid tank and the radiating pipe, the inlet and outlet of the radiating pipe of the oil-water heat exchanger are connected to the hydraulic system of the vibration table, the inlet and outlet of the radiating pipe of the water-water heat exchanger are connected to the outlet and inlet of the liquid tank of the oil-water heat exchanger respectively, and the liquid inlet and outlet of the liquid tank of the water-water heat exchanger are connected to the right flow-making corridor and the left flow-making corridor, respectively.

Further, the two groups of partition walls are symmetrically distributed on both sides of the internal reservoir.

Further, multiple sets of oil-water heat exchanger and water-water heat exchanger are arranged.

Further, the cooling system also includes an upper pool and an upper flow-making corridor, both the upper pool and the upper flow-making corridor are located at the top of the cooling pool, the upper flow-making corridor is connected to the left flow-making corridor and the right flow-making corridor, and the upper flow-making corridor is connected to the upper pool through a flow-making pump.

The present disclosure has the following beneficial effects:

1. the present disclosure separates the water body between the outlet and the inlet of the water-water heat exchanger by using the partition walls of the flow-making corridor, which ensures the full cooling process;

2. the pressure difference between the pumping pipe and the return pipe is used to make the reservoir water flow in the cooling water pool, thereby improving the heat dissipation efficiency; and

3. the cooling pool in the present disclosure can be used as a flow-making facility and will not cause idle resources. Deservedly, when there is a flow-making facility near the vibration table, the flow-making facility can also be modified in a small range, and as a cooling system, it can save the construction cost of the cooling pool.

### BRIEF DESCRIPTION OF THE DRAWINGS

FIG. 1 is an upper schematic plan of a hydraulic oil cooling system for a vibration table of the present disclosure.

FIG. 2 is a lower schematic plan of a hydraulic oil cooling system for a vibration table of the present disclosure.

FIG. 3 shows an a-a section view of a hydraulic oil cooling system for a vibration table of the present disclosure.

FIG. 4 shows a b-b section view of a hydraulic oil cooling system for a vibration table of the present disclosure.

FIG. 5 shows a c-c section view of a hydraulic oil cooling system for a vibration table of the present disclosure.

FIG. 6 is a schematic diagram of a liquid flow direction in an oil-water heat exchanger and a water-water heat exchanger of a hydraulic oil cooling system for a vibration table of the present disclosure.

Wherein, 1. internal reservoir; 2. right external reservoir; 3. internal and external reservoir channel; 4. pumping pipe; 5. return pipe; 6. left flow-making corridor; 7. right flow-making corridor; 8. upper flow-making corridor; 9. flow-making pump; 10. upper pool; 11. vibration table; 12. oil-water heat exchanger; 13. water-water heat exchanger; 14. left external reservoir; 15. barrier wall; 16. partition wall; and 17. ramp.

### DETAILED DESCRIPTION OF THE EMBODIMENTS

In order to achieve the above objective and effects, combined with the drawings, the technical means and structure adopted in the present disclosure are used to illustrate the characteristics and functions of the optimal embodiments of the present disclosure.

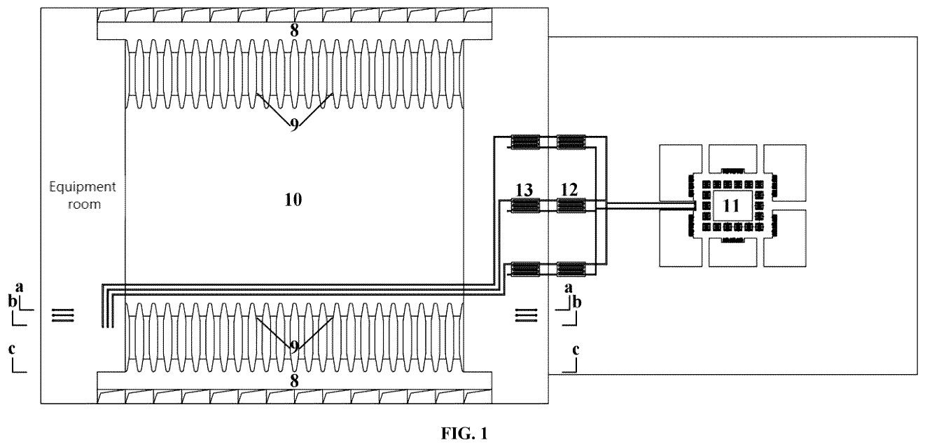

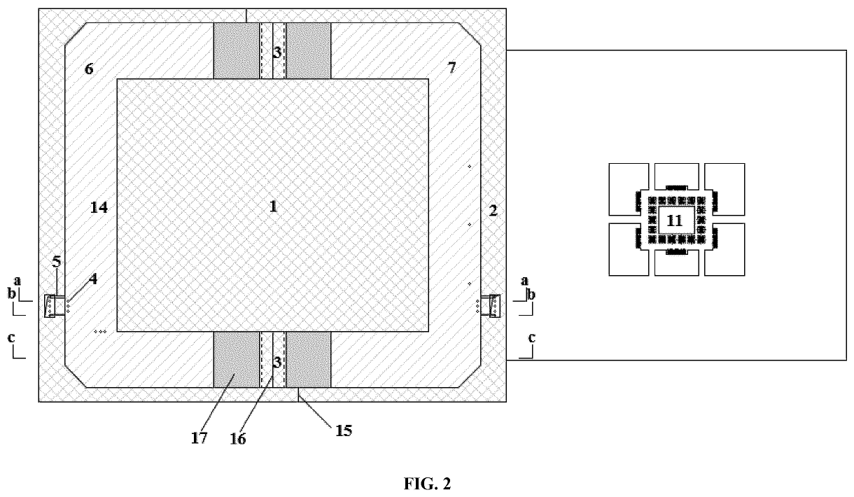

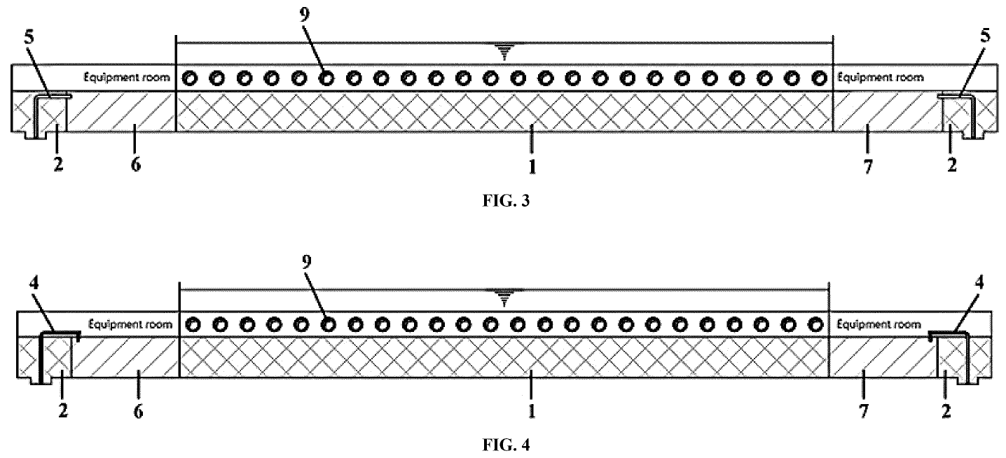

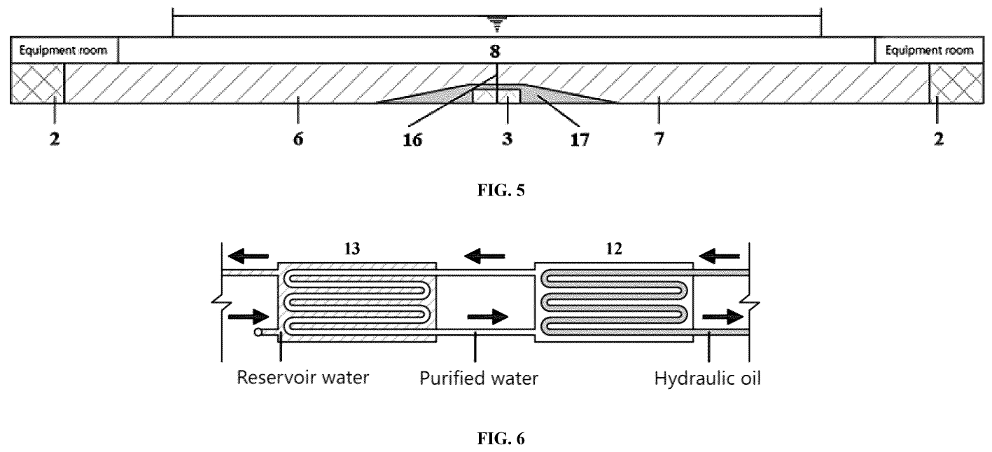

As shown in FIGS. 1-6, the present disclosure provides a hydraulic oil cooling system for a vibration table, including:

an oil-water heat exchanger 12, which is configured to cool the hydraulic oil of the vibration table 11;

a water-water heat exchanger 13, which is configured to cool the oil-water heat exchange 12;

a cooling pool, which is configured to provide cooling water for the water-water heat exchanger 13; and

the cooling pool includes an internal reservoir 1, a corridor and an external reservoir arranged from the inside out; two sets of partition walls 16 are arranged at an interior of the corridor, the two groups of partition walls 16 are symmetrically distributed on both sides of the internal reservoir 1, the two sets of partition walls 16 divide the corridor into a left flow-making corridor 6 and a right flow-making corridor 7, a ramp 17 is arranged under the partition wall 16, an internal and external reservoir channel 3 for connecting the internal reservoir 1 and the external reservoir is arranged at an interior of the ramp 17; two sets of barrier walls 15 are arranged at an interior of the external reservoir, the two sets of barrier walls 15 separate the external reservoir into a left external reservoir 14 and a right external reservoir 2, the left external reservoir 14 and the right external reservoir 2 are connected to the internal reservoir 1 through one internal and external reservoir channel 3, respectively; and the left flow-making channel 6 and the left external reservoir 14, as well as the right flow-making channel 7 and the right external reservoir 2, are connected by a pumping pipe 4 and a return pipe 5.

Both the oil-water heat exchanger 12 and the water-water heat exchanger 13 include a liquid tank and a radiating pipe located at an interior of the liquid tank, a liquid inlet and an outlet are arranged on both the liquid tank and the radiating pipe, the inlet and outlet of the radiating pipe of the oil-water heat exchanger 12 are connected to the hydraulic system of the vibration table 11, the inlet and outlet of the radiating pipe of the water-water heat exchanger 13 are connected to the outlet and inlet of the liquid tank of the oil-water heat exchanger 12, respectively, and the liquid inlet and outlet of the liquid tank of the water-water heat exchanger 13 are connected to the right flow-making corridor 7 and the left flow-making corridor 6, respectively. A circulating pump for both the oil-water heat exchanger 12 and the water-water heat exchanger 13 is self-contained, to allow liquid flow. Because the pressure of the hydraulic oil in the radiating pipe of the oil-water heat exchanger is larger, purified water is used to cool the radiating pipe of the oil-water heat exchanger to protect the pipeline; and the water pressure in the radiating pipe of the water-water heat exchanger is smaller, and the water in the reservoir can be used to cool the radiating pipe of the water-water heat exchanger.

When used, the hydraulic oil of the hydraulic system of the vibration table 11 circulates into the radiating pipe in the oil-water heat exchanger 12, the purified water in the liquid tank of the oil-water heat exchanger 12 cools the radiating pipe in the oil-water heat exchanger 12; the purified water in the liquid tank of the oil-water heat exchanger 12 circulates into the radiating pipe in the water-water heat exchanger 13; the water-water heat exchanger 13 draws reservoir water from the right flow-making corridor 7 to the liquid tank of the water-water heat exchanger 13, to cool the radiating pipe in the water-water heat exchanger 13; the reservoir water in the liquid tank of the water-water heat exchanger 13 is discharged into the left flow-making corridor 6 after heat exchange, after the reservoir water in the left flow-making corridor 6 reaches a certain amount, the return pipe 5 connected to the left flow-making corridor 6 is opened and the reservoir water in the left flow-making corridor is discharged into the left outer reservoir 14, the pressure on the left external reservoir 14 increases, through the internal and external reservoir channel 3 connected to the left external reservoir, the pressure is released to the internal reservoir 1, the internal reservoir 1 releases pressure to the right external reservoir 2 through another internal and external reservoir channel 3 until the water surface of the internal and external reservoirs is flat, realizing the flow cooling, and compared with the static pool, the heat dissipation efficiency is improved; when the reservoir water in the right flow-making corridor 7 is reduced to a certain amount, the pumping pipe 4 connected to the right flow-making corridor is opened, and the water is pumped from the right external reservoir 2.

In another embodiment, multiple sets of oil-water heat exchanger 12 and water-water heat exchanger 13 are arranged, to improve the heat exchange efficiency.

In another embodiment, the cooling system also includes an upper pool 10 and an upper flow-making corridor 8, both the upper pool 10 and the upper flow-making corridor 8 are located at the top of the cooling pool, the upper flow-making corridor 8 is connected to the left flow-making corridor 6 and the right flow-making corridor 7, and the upper flow-making corridor 8 is connected to the upper pool 10 through a flow-making pump 9. When the vibration table 11 is not used, the cooling system can be used as a flow-making facility and will not cause idle resources. Deservedly, when there is a flow-making facility near the vibration table, the flow-making facility can also be modified in a small range, and as a cooling system, it can save the construction cost of the cooling pool.

The above description are only the better embodiments of the present disclosure, not all embodiments. Anyone should know that the structural changes made under the inspiration of the present disclosure, and all technical solutions that are the same or similar to the present disclosure belong to the scope of protection of the present disclosure.

1. A hydraulic oil cooling system for a vibration table, comprising:
an oil-water heat exchanger configured to cool hydraulic oil of the vibration table,
a water-water heat exchanger configured to cool the oil-water heat exchange, and
a cooling pool configured to provide cooling water for the water-water heat exchanger;
wherein the cooling pool comprises an internal reservoir, a corridor and an external reservoir arranged from the inside out; two sets of partition walls are arranged at an interior of the corridor, the two sets of partition walls divide the corridor into a left flow-making corridor and a right flow-making corridor, an internal and external reservoir channel for connecting the internal reservoir and the external reservoir is arranged under the two sets of partition walls; two sets of barrier walls are arranged at an interior of the external reservoir, the two sets of barrier walls separate the external reservoir into a left external reservoir and a right external reservoir, the left external reservoir and the right external reservoir are connected to the internal reservoir through one internal and external reservoir channel, respectively; and the left flow-making channel and the left external reservoir are connected by a first pumping pipe and a first return pipe, the right flow-making channel and the right external reservoir are connected by a second pumping pipe and a second return pipe; and
both the oil-water heat exchanger and the water-water heat exchanger comprise a liquid tank and a radiating pipe located at an interior of the liquid tank, a liquid inlet and an outlet are arranged on both the liquid tank and the radiating pipe, an inlet and an outlet of the radiating pipe of the oil-water heat exchanger are connected to a hydraulic system of the vibration table, an inlet and an outlet of the radiating pipe of the water-water heat exchanger are connected to an outlet and an inlet of the liquid tank of the oil-water heat exchanger respectively, and an inlet and an outlet of the liquid tank of the water-water heat exchanger are connected to the right flow-making corridor and the left flow-making corridor, respectively.

2. The hydraulic oil cooling system for the vibration table according to claim 1, wherein the two sets of partition walls are symmetrically distributed on two sides of the internal reservoir.

3. The hydraulic oil cooling system for the vibration table according to claim 1, wherein multiple sets of oil-water heat exchanger and water-water heat exchanger are arranged.

4. The hydraulic oil cooling system for the vibration table according to claim 1, further comprising an upper pool and an upper flow-making corridor, wherein both the upper pool and the upper flow-making corridor are located at a top of the cooling pool, the upper flow-making corridor is connected to the left flow-making corridor and the right flow-making corridor, and the upper flow-making corridor is connected to the upper pool through a flow-making pump.

5. The hydraulic oil cooling system for the vibration table according to claim 2, further comprising an upper pool and an upper flow-making corridor, wherein both the upper pool and the upper flow-making corridor are located at a top of the cooling pool, the upper flow-making corridor is connected to the left flow-making corridor and the right flow-making corridor, and the upper flow-making corridor is connected to the upper pool through a flow-making pump.

6. The hydraulic oil cooling system for the vibration table according to claim 3, further comprising an upper pool and an upper flow-making corridor, wherein both the upper pool and the upper flow-making corridor are located at a top of the cooling pool, the upper flow-making corridor is connected to the left flow-making corridor and the right flow-making corridor, and the upper flow-making corridor is connected to the upper pool through a flow-making pump.
